(19) United States
(12) Patent Application Publication
(10) Pub. No.: US 2021/0156267 A1
(43) Pub. Date: May 27, 2021

(54) METHODS FOR DEPOSITING PROTECTIVE COATINGS ON TURBINE BLADES AND OTHER AEROSPACE COMPONENTS

(71) Applicant: Applied Materials, Inc., Santa Clara, CA (US)

(72) Inventors: Sukti CHATTERJEE, San Jose, CA (US); Lance A. SCUDDER, Sunnyvale, CA (US); David Alexander BRITZ, San Jose, CA (US); Kenichi OHNO, Sunnyvale, CA (US)

(21) Appl. No.: 16/821,427

(22) Filed: Mar. 17, 2020

Related U.S. Application Data
(60) Provisional application No. 62/938,598, filed on Nov. 21, 2019.

(51) Int. Cl. F01D 5/28; F01D 5/00

(52) U.S. Cl. CPC F01D 5/288; F01D 5/005; F05D 2300/121; F05D 2230/90; F05D 2230/313; F05D 2220/323; F05D 2300/611

(57) ABSTRACT

Embodiments of the present disclosure generally relate to protective coatings on turbine blades, turbine disks, and other aerospace components and methods for depositing the protective coatings. In one or more embodiments, a turbine blade includes a blade portion and a root coupled to the blade portion, where the root contains a protective coating disposed thereon. The protective coating is or contains one or more deposited crystalline film containing at least one of a metal oxide, a metal nitride, or a metal oxynitride and has a thickness of about 100 nm to about 10 μm. In some examples, a turbine blade assembly includes a disk and a plurality of the turbine blades coupled to the disk. The protective coating is disposed on the root on the turbine blade and/or a receiving surface on the turbine disk.

### CROSS-REFERENCE TO RELATED APPLICATIONS

This application claims benefit to U.S. Appl. No. 62/938,598, filed on Nov. 21, 2019, which is herein incorporated by reference.

### BACKGROUND

### Field

Embodiments of the present disclosure generally relate to deposition processes, and in particular to vapor deposition processes for depositing films on aerospace components.

### Description of the Related Art

Turbine engines typically have components which corrode or degrade over time due to being exposed to hot gases and/or reactive chemicals (e.g., acids, bases, or salts). Such turbine components are often protected by a thermal and/or chemical barrier coating. The current coatings used on airfoils exposed to the hot gases of combustion in gas turbine engines for both environmental protection and as bond coats in thermal barrier coating (TBC) systems include both diffusion aluminides and various metal alloy coatings. These coatings are applied over substrate materials, typically nickel-based superalloys, to provide protection against oxidation and corrosion attack. These coatings are formed on the substrate in a number of different ways. For example, a nickel aluminide layer may be grown as an outer coat on a nickel base superalloy by simply exposing the substrate to an aluminum rich environment at elevated temperatures. The aluminum diffuses into the substrate and combines with the nickel to form an outer surface of the nickel-aluminum alloy.

Most of the thermal barrier coatings are on the order of greater than 10 micrometers in thickness, which can cause component weight to increase, making design of the disks and other support structures more challenging. Many of these coatings also require high temperature (e.g., greater than 500° C.) steps to deposit or promote enough interdiffusion of the coating into the alloy to achieve adhesion. It is desired by many to have coatings that (1) protect metals from oxidation and corrosion, (2) are capable of high film thickness and composition uniformity on arbitrary geometries, (3) have high adhesion to the metal, (4) are sufficiently thin to not materially increase weight or reduce fatigue life outside of current design practices for bare metal, and/or (5) are deposited at sufficiently low temperature (e.g., 500° C. or less) to not cause microstructural changes to the metal.

Therefore, improved protective coatings on aerospace components and methods for depositing the protective coatings are needed.

### SUMMARY

Embodiments of the present disclosure generally relate to protective coatings on turbine blades, turbine disks, and other aerospace components and methods for depositing the protective coatings.

In one or more embodiments, a turbine blade is provided and includes a blade portion and a root coupled to the blade portion, where the root contains a protective coating disposed thereon. The protective coating is or contains one or more deposited crystalline films containing at least one of a metal oxide, a metal nitride, or a metal oxynitride and has a thickness of about 100 nm to about 10 μm.

In other embodiments, a turbine blade assembly includes a disk and a plurality of the turbine blades coupled to the disk. The protective coating is disposed on the root on the turbine blade and/or a receiving surface on the turbine disk. The disk generally includes a plurality of receiving surfaces, such that each of the turbine blades is coupled to a respective receiving surface of the plurality of receiving surfaces. Each of the receiving surfaces can include a disk protective coating disposed thereon. The disk protective coating contains a second deposited crystalline film containing at least one of a metal oxide, a metal nitride, or a metal oxynitride and has a thickness of about 100 nm to about 10 μm.

In some embodiments, a method for producing, forming, or otherwise depositing the protective coating on the turbine blade root, the turbine disk, and/or other aerospace component is provided and includes depositing one or more metal oxide films by a vapor deposition process.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1A depicts a turbine assembly, according to one or more embodiments described and discussed herein.

FIG. 1B depicts a turbine blade assembly containing one or more protective coatings on one or more aerospace components thereof, according to one or more embodiments described and discussed herein.

FIG. 2 depicts a turbine blade assembly having open tip turbine blades and containing one or more protective coatings on one or more aerospace components thereof, according to one or more embodiments described and discussed herein.

FIG. 3 depicts a turbine blade assembly having shrouded tip turbine blades and containing one or more protective coatings on one or more aerospace components thereof, according to one or more embodiments described and discussed herein.

FIGS. 4A-4B depict a turbine blade containing a protective coating disposed on the root, according to one or more embodiments described and discussed herein.

To facilitate understanding, identical reference numerals have been used, where possible, to designate identical elements that are common to the Figures. It is contemplated that elements and features of one or more embodiments may be beneficially incorporated in other embodiments.

### DETAILED DESCRIPTION

Embodiments of the present disclosure generally relate to protective coatings on turbine blades (e.g., blade roots), turbine disks, and other aerospace components and methods for depositing the protective coatings. The protective coatings reduces or eliminates stress corrosion cracking of the turbine blade, the turbine disk, and other aerospace components. The protective coatings does not affect weight, dimensional tolerances, low cycle fatigue life, and/or thermal conductivity of the turbine blade, the turbine disk, and other aerospace components. The protective coatings can be or include monolayer films, multi-layer films, nanolaminate film stacks, coalesced films, crystalline films, or any combination thereof.

In one or more embodiments, a turbine blade is provided and includes a blade portion and a root coupled to the blade portion, where the root contains a protective coating disposed thereon. The protective coating is or contains one or more deposited crystalline film containing at least one or more metal oxides, one or more metal nitrides, one or more metal oxynitrides, and/or any combination thereof. Each of the metal oxide, the metal nitride, and/or the metal oxynitride can independently be crystalline. The protective coating can have a thickness of about 100 nm to about 10 μm. In some examples, a turbine blade assembly includes a disk and a plurality of the turbine blades coupled to the disk. The protective coating is disposed on the root on the turbine blade and/or a receiving surface on the turbine disk.

In other embodiments, a method for producing, forming, or otherwise depositing the protective coating on the turbine blade root, the turbine disk, and/or other aerospace component is provided and includes depositing one or more metal oxide films by a vapor deposition process.

In some embodiments, the aerospace component as described and discussed herein can be or include one or more turbine blades, turbine blade roots (e.g., fir tree or dovetail), turbine disks, or any combination thereof. In other embodiments, the aerospace components as described and discussed herein can be or include any other aerospace component or part that can benefit from having protective coating deposited thereon. The protective coatings can be deposited or otherwise formed on interior surfaces and/or exterior surfaces of the aerospace components.

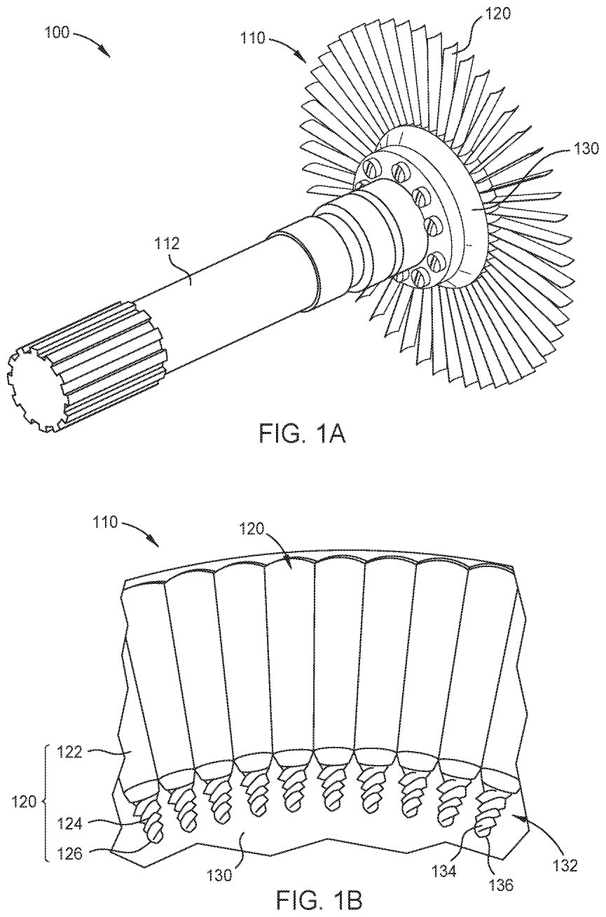

FIG. 1A depicts a turbine assembly 100, according to one or more embodiments described and discussed herein. The turbine assembly 100 includes a turbine blade assembly 110 and a shaft 112 coupled together. The turbine blade assembly 110 includes a plurality of the turbine blades 120 coupled to a turbine disk 130. The shaft 112 can be attached, coupled to, otherwise a fixed with the turbine disk 130. The plurality of the turbine blades 120 can include 10 blades, about 20 blades, about 40 blades, or about 50 blades to about 60 blades, about 80 blades, about 100 blades, about 150 blades, about 180 blades, about 200 blades, or more blades. For example, the turbine blade assembly 110 can include about 10 blades, to about 200 blades, about 50 blades to about 200 blades, about 100 blades to about 200 blades, about 10 blades, to about 150 blades, about 50 blades to about 150 blades, or about 100 blades to about 150 blades.

FIG. 1B depicts further detail to the turbine blade assembly 110 containing the turbine blades 120 coupled to the turbine disk 130. Each of the turbine blades 120 contains a blade portion 122 and a root 124 (e.g., blade root or turbine blade root). The root 124 can also be referred to as a “fir tree” or a “fir tree root”. A protective coating 126 is deposited or otherwise disposed on at least the root 124, and can also be on other portions of the turbine blade 120.

The turbine disk 130 includes a plurality of notches or grooves 132 which can have the reciprocal geometry as the geometry of the root 124. Each of the grooves 132 have a receiving surface 134 for receiving the root 124. A protective coating 136 (e.g., disk protective coating) is deposited or otherwise disposed on at least the receiving surface 134, and can also be on other portions of the turbine disk 130.

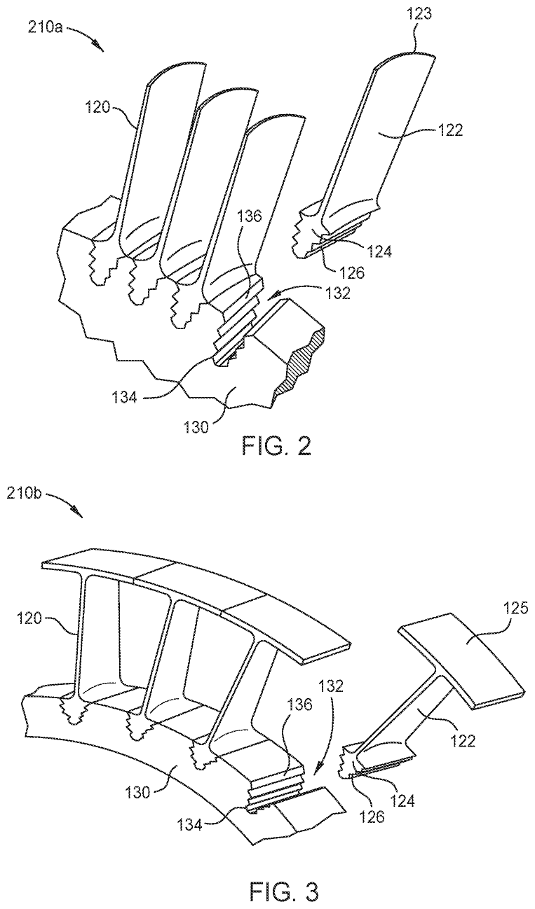

FIG. 2 depicts a turbine blade assembly 210a having open tip turbine blades 123 and containing one or more protective coatings 126, 136, according to one or more embodiments described and discussed herein. The protective coating 126 is deposited or otherwise disposed on the root 124 and the protective coating 136 is deposited or otherwise disposed on at least the receiving surface 134 of the turbine disk 130.

FIG. 3 depicts a turbine blade assembly 210b having shrouded tip turbine blades 125 and containing one or more protective coatings 126, 136, according to one or more embodiments described and discussed herein. The protective coating 126 is deposited or otherwise disposed on the root 124 and the protective coating 136 is deposited or otherwise disposed on at least the receiving surface 134 of the turbine disk 130.

Although the turbine blade assembly 210a with open tip turbine blades 123 (FIG. 2) and the turbine blade assembly 210b with shrouded tip turbine blades 125 (FIG. 3) are shown in the Figures, the protective coating 126 can be deposited or otherwise disposed on any turbine blades regardless of the type of tip, the lack of a tip, the shape blade, and/or size of the blade.

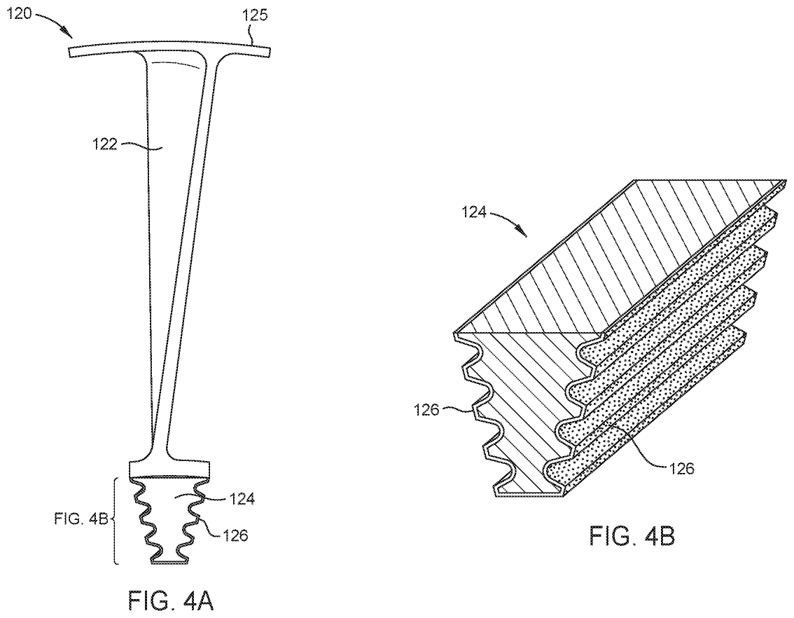

FIGS. 4A-4B depict the turbine blade 120 containing the protective coating 126 deposited or otherwise disposed on the root 124, according to one or more embodiments described and discussed herein.

In one or more embodiments, the protective coating 126 and the disk protective coating 136 can independently be or include one or more deposited crystalline films which contains one or more crystalline metal oxides, one or more crystalline metal nitrides, one or more crystalline metal oxynitrides, or any combination thereof. In some examples, the deposited crystalline films can be or include one or more deposited crystalline metal oxide films. Each of the deposited crystalline metal oxide films can be or include one or more crystalline layers and/or one or more crystalline materials. In some embodiments, the protective coating 126 and the disk protective coating 136 can independently be or include one or more crystalline materials, such as aluminum oxide, aluminum silicate, aluminum nitride, aluminum oxynitride, chromium oxide, chromium silicate, silicon oxide, silicon nitride, silicon carbide, yttrium oxide, yttrium silicate, yttrium nitride, yttrium silicon nitride, hafnium oxide, hafnium nitride, hafnium silicide, hafnium silicate, titanium oxide, titanium nitride, titanium silicide, titanium silicate, dopants thereof, alloys thereof, or any combination thereof. In one or more examples, the protective coating 126 and the disk protective coating 136 can independently be or include one or more of aluminum oxide, chromium oxide, hafnium oxide, yttrium oxide, dopants thereof, alloys thereof, or any combination thereof.

In one or more embodiments, each of the protective coating 126 and the disk protective coating 136 can independently have a thickness of about 100 nm, about 200 nm, about 300 nm, about 400 nm, about 500 nm, about 650 nm, about 800 nm, or about 1 μm to about 1.5 μm, about 2 μm, about 2.5 μm, about 3 μm, about 4 μm, about 5 μm, about 6 μm, about 7 μm, about 8 μm, about 9 μm, or about 10 μm. For example, the protective coating 126 and the disk protective coating 136 can independently have a thickness of about 100 nm to about 10 μm, about 100 nm to about 8 μm, about 100 nm to about 7 μm, about 100 nm to about 5 μm, about 100 nm to about 4 μm, about 100 nm to about 3.5 μm, about 100 nm to about 3 μm, about 100 nm to about 2.5 μm, about 100 nm to about 2 μm, about 100 nm to about 1.5 μm, about 100 nm to about 1 μm, about 100 nm to about 500 nm, about 100 nm to about 400 nm, about 100 nm to about 300 nm, about 200 nm to about 10 μm, about 200 nm to about 8 μm, about 200 nm to about 7 μm, about 200 nm to about 5 μm, about 200 nm to about 4 μm, about 200 nm to about 3.5 μm, about 200 nm to about 3 μm, about 200 nm to about 2.5 μm, about 200 nm to about 2 μm, about 200 nm to about 1.5 μm, about 200 nm to about 1 μm, about 200 nm to about 500 nm, about 200 nm to about 400 nm, about 200 nm to about 300 nm, about 500 nm to about 10 μm, about 500 nm to about 8 μm, about 500 nm to about 7 μm, about 500 nm to about 5 μm, about 500 nm to about 4 μm, about 500 nm to about 3.5 μm, about 500 nm to about 3 μm, about 500 nm to about 2.5 μm, about 500 nm to about 2 μm, about 500 nm to about 1.5 μm, or about 500 nm to about 1 μm.

In one or more embodiments, each of the protective coating 126, the disk protective coating 136, the deposited crystalline film, the second deposited crystalline film, the deposited crystalline metal oxide film, and/or the second deposited crystalline metal oxide film can independently have a thickness variation of less than 500%, such as less than or about 400%, less than or about 300%, less than or about 200%, less than or about 150%, less than or about 100%, less than or about 50%, less than or about 20%, less than or about 18%, less than or about 15%, less than or about 12%, less than or about 10%, less than or about 8%, less than or about 6%, less than or about 5%, less than or about 4%, less than or about 3%, less than or about 2%, or less than or about 1%.

In one or more embodiments, each of the protective coating 126, the disk protective coating 136, the deposited crystalline film, the second deposited crystalline film, the deposited crystalline metal oxide film, and/or the second deposited crystalline metal oxide film can independently be deposited by an atomic layer deposition (ALD) process, a plasma-enhanced ALD (PE-ALD) process, a thermal chemical vapor deposition (CVD) process, a plasma-enhanced CVD (PE-CVD) process, a pulsed-CVD process, a physical vapor deposition (PVD) process, a reactive PVD process, or any combination thereof.

In one or more embodiments, each of the protective coating 126, the disk protective coating 136, the substrate bulk temperature is less than or about 1,100° C. during deposition, less than or about 900° C. during deposition, less than or about 700° C. during deposition, less than or about 600° C. during deposition, less than or about 500° C. during deposition, less than or about 400° C. during deposition, less than or about 350° C. during deposition, less than or about 300° C. during deposition, less than or about 250° C. during deposition, less than or about 200° C. during deposition, or less than or about 150° C. during deposition. In some embodiments, each of the protective coating 126, the disk protective coating 136, the deposited film is crystalline immediately after deposition.

In one or more embodiments, each of the protective coating 126, the disk protective coating 136, the deposited crystalline film, the second deposited crystalline film, the deposited crystalline metal oxide film, and/or the second deposited crystalline metal oxide film can independently be annealed or otherwise heated during and/or after any deposition process. In some examples, the annealing process can be or include a thermal anneal (e.g., rapid thermal processing (RTP) or furnace anneal), a plasma anneal, a light anneal (e.g., a laser anneal, an ultraviolet anneal, an infrared anneal, or a visible light anneal), or any combination thereof.

In one or more embodiments, each of the protective coating 126, the disk protective coating 136, the substrate bulk temperature is less than or about 1,100° C. during the annealing process, less than or about 900° C. during the annealing process, less than or about 700° C. during the annealing process, less than or about 600° C. during the annealing process, less than or about 500° C. during the annealing process, less than or about 400° C. during the annealing process, less than or about 350° C. during the annealing process, less than or about 300° C. during the annealing process, less than or about 250° C. during the annealing process, less than or about 200° C. during the annealing process, or less than or about 150° C. during the annealing process.

### Clean Process

Prior to producing or otherwise depositing the protective coating, the aerospace component can optionally be exposed to one or more cleaning processes. One or more contaminants are removed from the aerospace component to produce the cleaned surface during the cleaning process. The contaminant can be or include oxides, organics or organic residues, carbon, oil, soil, particulates, debris, and/or other contaminants, or any combination thereof. These contaminants are removed prior to producing the protective coating on the aerospace component.

The cleaning process can be or include one or more basting or texturing processes, vacuum purges, solvent clean, acid clean, basic or caustic clean, wet clean, ozone clean, plasma clean, sonication, or any combination thereof. Once cleaned and/or textured, the subsequently deposited protective coating has stronger adhesion to the cleaned surfaces or otherwise altered surfaces of the aerospace component than if otherwise not exposed to the cleaning process.

In one or more examples, the surfaces of the aerospace component can be blasted with or otherwise exposed to beads, sand, carbonate, or other particulates to remove oxides and other contaminates therefrom and/or to provide texturing to the surfaces of the aerospace component. In some examples, the aerospace component can be placed into a chamber within a pulsed push-pull system and exposed to cycles of purge gas or liquid (e.g., N₂, Ar, He, one or more alcohols (methanol, ethanol, propanol, and/or others), H₂O, or any combination thereof) and vacuum purges to remove debris from small holes on the aerospace component. In other examples, the surfaces of the aerospace component can be exposed to hydrogen plasma, oxygen or ozone plasma, and/or nitrogen plasma, which can be generated in a plasma chamber or by a remote plasma system.

In some examples, such as for organic removal or oxide removal, the surfaces of the aerospace component can be exposed to a hydrogen plasma, then degassed, then exposed to ozone treatment. In other examples, such as for organic removal, the surfaces of the aerospace component can be exposed to a wet clean that includes: soaking in an alkaline degreasing solution, rinsing, exposing the surfaces to an acid clean (e.g., sulfuric acid, phosphoric acid, hydrochloric acid, hydrofluoric acid, or any combination thereof), rinsing, and exposing the surfaces deionized water sonication bath. In some examples, such as for oxide removal, the surfaces of the aerospace component can be exposed to a wet clean that includes: exposing the surfaces to a dilute acid solution (e.g., acetic acid hydrochloric acid, hydrofluoric acid, or combinations thereof), rinsing, and exposing the surfaces deionized water sonication bath. In one or more examples, such as for particle removal, the surfaces of the aerospace component can be exposed to sonication (e.g., megasonication) and/or a supercritical fluid (carbon dioxide, water, one or more alcohols) wash, followed by exposing to cycles of purge gas or liquid (e.g., N₂, Ar, He, one or more alcohols, H₂O, or any combination thereof) and vacuum purges to remove particles from and dry the surfaces. In some examples, the aerospace component can be exposed to heating or drying processes, such as heating the aerospace component to a temperature of about 50° C., about 65° C., or about 80° C. to about 100° C., about 120° C., or about 150° C. and exposing to surfaces to the purge gas. The aerospace component can be heated in an oven or exposed to lamps for the heating or drying processes. Optionally, hot gas can be forced through internal passages to accelerate drying. Optionally, the component can be dried in reduced atmosphere without heating or with heating.

In various embodiments, the cleaned surface of the aerospace component can be one or more interior surfaces and/or one or more exterior surfaces of the aerospace component. The cleaned surface of the aerospace component can be or include one or more material, such as nickel, nickel superalloy, stainless steel, cobalt, chromium, molybdenum, iron, titanium, alloys thereof, or any combination thereof. In one or more examples, the cleaned surface of the aerospace component has an aspect ratio of about 5 to about 1,000, such as about 20 to about 500.

In some examples, the protective coating has a thickness of about 10 nm to about 5,000 nm, about 100 nm to about 4,000 nm, or about 500 nm to about 2,000 nm. Also, the protective coating can have a thickness variation of less than 200%, less than 100%, less than 25%, less than 5%, or less than 0.5%.

### Vapor Deposition Process

In one or more embodiments, the protective coating reduces or suppresses low cycle fatigue life and/or stress corrosion cracking of the turbine blade, the turbine disk, and other aerospace components. In some examples, the protective coating can be or include one or more material, such as aluminum oxide, aluminum silicate, aluminum nitride, aluminum oxynitride, chromium oxide, chromium nitride, chromium silicate, silicon oxide, silicon nitride, silicon carbide, yttrium oxide, yttrium silicate, yttrium nitride, yttrium silicon nitride, hafnium oxide, hafnium nitride, hafnium silicide, hafnium silicate, titanium oxide, titanium nitride, titanium silicide, titanium silicate, cerium oxide, dopants thereof, alloys thereof, or any combination thereof. In one or more examples, the protective coating can be or include one or more material, such as aluminum oxide, chromium oxide, hafnium oxide, yttrium oxide, dopants thereof, alloys thereof, or any combination thereof.

In one or more embodiments, a method for depositing a protective coating on an aerospace component includes sequentially exposing the aerospace component to an aluminum precursor and one or more reactants to form an aluminum-containing layer on a surface the aerospace component by an ALD process. In some examples, the reactant can be or contain one or more oxidizing agents and/or one or more nitriding agents. The oxidizing agent can be or contain water, ozone, oxygen (O₂), atomic oxygen, nitrous oxide, one or more peroxides (e.g., hydrogen peroxide, other inorganic peroxides, organic peroxides), one or more alcohols (e.g., methanol, ethanol, propanol, or higher alcohols), plasmas thereof, or any combination thereof. The nitriding agent can be or contain ammonia, nitric oxide, atomic nitrogen, a hydrazine, plasmas thereof, or any combination thereof. The aluminum-containing layer contains aluminum oxide, aluminum nitride, aluminum oxynitride, or any combination thereof.

In other embodiments, a method for depositing a protective coating on an aerospace component includes sequentially exposing the aerospace component to a chromium precursor and a reactant to form a chromium-containing layer on a surface the aerospace component by an ALD process. The chromium-containing layer contains metallic chromium, chromium oxide, chromium nitride, chromium carbide, chromium silicide, or any combination thereof.

In some embodiments, a nanolaminate film stack is formed on the surface of the aerospace component, where the nanolaminate film stack contains alternating layers of the metal oxide layer (e.g., oxide of Al, Cr, Hf, and/or Y) and a second deposited layer. The aerospace component can be sequentially exposed to a metal or silicon precursor and a second reactant to form the second deposited layer on the surface by ALD. The second deposited layer contains aluminum oxide, aluminum nitride, silicon oxide, silicon nitride, silicon carbide, yttrium oxide, yttrium nitride, yttrium silicon nitride, hafnium oxide, hafnium nitride, hafnium silicide, hafnium silicate, titanium oxide, titanium nitride, titanium silicide, titanium silicate, or any combination thereof. The nanolaminate film stack containing the alternating layers of the chromium-containing layer and the second deposited layer can be used as the protective coating on the aerospace component. Alternatively, in other embodiments, the nanolaminate film stack disposed on the aerospace component can be exposed to an annealing process to convert the nanolaminate film stack into a coalesced film, which can be used as the protective coating on the aerospace component.

In one or more embodiments, the protective coating contains a nanolaminate film stack containing one pair or a plurality of pairs of a first deposited layer and a second deposited layer sequentially deposited or otherwise formed on the aerospace component. The nanolaminate film stack is illustrated with four pairs of the first and second deposited layers, however, the nanolaminate film stack can contain any number of the first and second deposited layers, as further discussed below. For example, the nanolaminate film stack can contain from one pair of the first and second deposited layers to about 150 pairs of the first and second deposited layers. In other embodiments, not shown, the protective coating is not a nanolaminate film stack, but instead contains the first deposited layer or the second deposited layer deposited or otherwise formed on the aerospace component. In further embodiments, the nanolaminate film stack containing one or more pairs of the first and second deposited layers are initially deposited, then is converted to a coalesced film or a crystalline film.

In other embodiments, the protective coating contains a nanolaminate film stack. The nanolaminate film stack contains a first deposited layer and a second deposited layer, and the method further includes depositing from 2 pairs to about 500 pairs of the first deposited layer and the second deposited layer while increasing a thickness of the nanolaminate film stack. In one or more examples, each pair of the first deposited layer and the second deposited layer can have a thickness of about 0.2 nm to about 500 nm. In some examples, the method further includes annealing the aerospace component and converting the nanolaminate film stack into a coalesced film or a crystalline film.

The vapor deposition process can be an ALD process, a plasma-enhanced ALD (PE-ALD) process, a thermal chemical vapor deposition (CVD) process, a plasma-enhanced CVD (PE-CVD) process, a pulsed-CVD process, a physical vapor deposition (PVD) process, or any combination thereof. In some example, the deposition process is an ALD process and the aerospace component can be exposed to a first precursor and a first reactant to form the first deposited layer on the aerospace component.

In one or more embodiments, the vapor deposition process is an ALD process and the method includes sequentially exposing the surface of the aerospace component to the first precursor and the first reactant to form the first deposited layer. Each cycle of the ALD process includes exposing the surface of the aerospace component to the first precursor, conducting a pump-purge, exposing the aerospace component to the first reactant, and conducting a pump-purge to form the first deposited layer. The order of the first precursor and the first reactant can be reversed, such that the ALD cycle includes exposing the surface of the aerospace component to the first reactant, conducting a pump-purge, exposing the aerospace component to the first precursor, and conducting a pump-purge to form the first deposited layer.

In some examples, during each ALD cycle, the aerospace component is exposed to the first precursor for about 0.1 seconds to about 10 seconds, the first reactant for about 0.1 seconds to about 10 seconds, and the pump-purge for about 0.5 seconds to about 30 seconds. In other examples, during each ALD cycle, the aerospace component is exposed to the first precursor for about 0.5 seconds to about 3 seconds, the first reactant for about 0.5 seconds to about 3 seconds, and the pump-purge for about 1 second to about 10 seconds.

Each ALD cycle is repeated from 2, 3, 4, 5, 6, 8, about 10, about 12, or about 15 times to about 18, about 20, about 25, about 30, about 40, about 50, about 65, about 80, about 100, about 120, about 150, about 200, about 250, about 300, about 350, about 400, about 500, about 800, about 1,000, or more times to form the first deposited layer. For example, each ALD cycle is repeated from 2 times to about 1,000 times, 2 times to about 800 times, 2 times to about 500 times, 2 times to about 300 times, 2 times to about 250 times, 2 times to about 200 times, 2 times to about 150 times, 2 times to about 120 times, 2 times to about 100 times, 2 times to about 80 times, 2 times to about 50 times, 2 times to about 30 times, 2 times to about 20 times, 2 times to about 15 times, 2 times to about 10 times, 2 times to 5 times, about 8 times to about 1,000 times, about 8 times to about 800 times, about 8 times to about 500 times, about 8 times to about 300 times, about 8 times to about 250 times, about 8 times to about 200 times, about 8 times to about 150 times, about 8 times to about 120 times, about 8 times to about 100 times, about 8 times to about 80 times, about 8 times to about 50 times, about 8 times to about 30 times, about 8 times to about 20 times, about 8 times to about 15 times, about 8 times to about 10 times, about 20 times to about 1,000 times, about 20 times to about 800 times, about 20 times to about 500 times, about 20 times to about 300 times, about 20 times to about 250 times, about 20 times to about 200 times, about 20 times to about 150 times, about 20 times to about 120 times, about 20 times to about 100 times, about 20 times to about 80 times, about 20 times to about 50 times, about 20 times to about 30 times, about 50 times to about 1,000 times, about 50 times to about 500 times, about 50 times to about 350 times, about 50 times to about 300 times, about 50 times to about 250 times, about 50 times to about 150 times, or about 50 times to about 100 times to form the first deposited layer.

In other embodiments, the vapor deposition process is a CVD process and the method includes simultaneously exposing the aerospace component to the first precursor and the first reactant to form the first deposited layer. During an ALD process or a CVD process, each of the first precursor and the first reactant can independent include one or more carrier gases. One or more purge gases can be flowed across the aerospace component and/or throughout the processing chamber in between the exposures of the first precursor and the first reactant. In some examples, the same gas may be used as a carrier gas and a purge gas. Exemplary carrier gases and purge gases can independently be or include one or more of nitrogen (N₂), argon, helium, neon, hydrogen (H₂), or any combination thereof.

The first deposited layer can have a thickness of about 0.1 nm, about 0.2 nm, about 0.3 nm, about 0.4 nm, about 0.5 nm, about 0.8 nm, about 1 nm, about 2 nm, about 3 nm, about 5 nm, about 8 nm, about 10 nm, about 12 nm, or about 15 nm to about 18 nm, about 20 nm, about 25 nm, about 30 nm, about 40 nm, about 50 nm, about 60 nm, about 80 nm, about 100 nm, about 120 nm, or about 150 nm. For example, the first deposited layer can have a thickness of about 0.1 nm to about 150 nm, about 0.2 nm to about 150 nm, about 0.2 nm to about 120 nm, about 0.2 nm to about 100 nm, about 0.2 nm to about 80 nm, about 0.2 nm to about 50 nm, about 0.2 nm to about 40 nm, about 0.2 nm to about 30 nm, about 0.2 nm to about 20 nm, about 0.2 nm to about 10 nm, about 0.2 nm to about 5 nm, about 0.2 nm to about 1 nm, about 0.2 nm to about 0.5 nm, about 0.5 nm to about 150 nm, about 0.5 nm to about 120 nm, about 0.5 nm to about 100 nm, about 0.5 nm to about 80 nm, about 0.5 nm to about 50 nm, about 0.5 nm to about 40 nm, about 0.5 nm to about 30 nm, about 0.5 nm to about 20 nm, about 0.5 nm to about 10 nm, about 0.5 nm to about 5 nm, about 0.5 nm to about 1 nm, about 2 nm to about 150 nm, about 2 nm to about 120 nm, about 2 nm to about 100 nm, about 2 nm to about 80 nm, about 2 nm to about 50 nm, about 2 nm to about 40 nm, about 2 nm to about 30 nm, about 2 nm to about 20 nm, about 2 nm to about 10 nm, about 2 nm to about 5 nm, about 2 nm to about 3 nm, about 10 nm to about 150 nm, about 10 nm to about 120 nm, about 10 nm to about 100 nm, about 10 nm to about 80 nm, about 10 nm to about 50 nm, about 10 nm to about 40 nm, about 10 nm to about 30 nm, about 10 nm to about 20 nm, or about 10 nm to about 15 nm.

In one or more embodiments, the first precursor contains one or more chromium precursors, one or more aluminum precursors, or one or more hafnium precursors. The first reactant contains one or more reducing agents, one or more oxidizing agents, one or more nitriding agents, one or more silicon precursors, one or more carbon precursors, or any combination thereof. In some examples, the first deposited layer is a chromium-containing layer which can be or include metallic chromium, chromium oxide, chromium nitride, chromium silicide, chromium carbide, or any combination thereof. In other examples, the first deposited layer is an aluminum-containing layer which can be or include metallic aluminum, aluminum oxide, aluminum nitride, aluminum silicide, aluminum carbide, or any combination thereof. In further examples, the first deposited layer is a hafnium-containing layer which can be or include metallic hafnium, hafnium oxide, hafnium nitride, hafnium silicide, hafnium carbide, or any combination thereof.

The chromium precursor can be or include one or more of chromium cyclopentadiene compounds, chromium carbonyl compounds, chromium acetylacetonate compounds, chromium diazadienyl compounds, substitutes thereof, complexes thereof, abducts thereof, salts thereof, or any combination thereof. Exemplary chromium precursor can be or include bis(cyclopentadiene) chromium (Cp₂Cr), bis(pentamethylcyclopentadiene) chromium ((Me₅Cp)₂Cr), bis(isoproplycyclopentadiene) chromium ((iPrCp)₂Cr), bis(ethylbenzene) chromium ((EtBz)₂Cr), chromium hexacarbonyl (Cr(CO)₆), chromium acetylacetonate (Cr(acac)₃, also known as, tris(2,4-pentanediono) chromium), chromium hexafluoroacetylacetonate (Cr(hfac)₃), chromium(III) tris(2,2,6,6-tetramethyl-3,5-heptanedionate) {Cr(tmhd)₃}, chromium(II) bis(1,4-ditertbutyldiazadienyl), isomers thereof, complexes thereof, abducts thereof, salts thereof, or any combination thereof. Exemplary chromium diazadienyl compounds can have a chemical formula of:

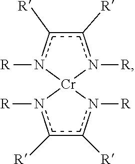

where each R and R′ is independently selected from H, C1-C6 alkyl, aryl, acyl, alkylamido, hydrazido, silyl, aldehyde, keto, C2-C4 alkenyl, alkynyl, or substitutes thereof. In some examples, each R is independently a C1-C6 alkyl which is selected from methyl, ethyl, propyl, butyl, or isomers thereof, and R′ is H. For example, R is methyl and R′ is H, R is ethyl and R′ is H, R is iso-propyl and R′ is H, or R is tert-butyl and R′ is H.

The aluminum precursor can be or include one or more of aluminum alkyl compounds, one or more of aluminum alkoxy compounds, one or more of aluminum acetylacetonate compounds, substitutes thereof, complexes thereof, abducts thereof, salts thereof, or any combination thereof. Exemplary aluminum precursors can be or include trimethylaluminum, triethylaluminum, tripropylaluminum, tributylaluminum, trimethoxyaluminum, triethoxyaluminum, tripropoxyaluminum, tributoxyaluminum, aluminum acetylacetonate (Al(acac)₃, also known as, tris(2,4-pentanediono) aluminum), aluminum hexafluoroacetylacetonate (Al(hfac)₃), trisdipivaloylmethanatoaluminum (DPM₃Al, (C₁₁H₁₉O₂)₃Al), isomers thereof, complexes thereof, abducts thereof, salts thereof, or any combination thereof.

In one or more examples, the precursor is or contains one or more aluminum alkyl compounds, such as trimethyl aluminum (TMA). The aluminum alkyl compound (e.g., TMA) has a purity of greater than 95%, greater than 97%, or greater than 99%, such as about 99.3%, about 99.5 wt %, about 99.7 wt %, or about 99.9 wt % to about 99.95 wt %, about 99.99 wt %, about 99.995 wt %, about 99.999 wt %, about 99.9999 wt %, or greater. In one or more examples, the aluminum alkyl compound (e.g., TMA) has a purity of 99.5 wt % or greater, such as about 99.9 wt % to about 99.999 wt %.

The hafnium precursor can be or include one or more of hafnium cyclopentadiene compounds, one or more of hafnium amino compounds, one or more of hafnium alkyl compounds, one or more of hafnium alkoxy compounds, substitutes thereof, complexes thereof, abducts thereof, salts thereof, or any combination thereof. Exemplary hafnium precursors can be or include bis(methylcyclopentadiene) dimethylhafnium ((MeCp)₂HfMe₂), bis(methylcyclopentadiene) methylmethoxyhafnium ((MeCp)₂Hf(OMe)(Me)), bis(cyclopentadiene) dimethylhafnium ((Cp)₂HfMe₂), tetra(tert-butoxy) hafnium, hafniumum isopropoxide ((iPrO)₄Hf), tetrakis(dimethylamino) hafnium (TDMAH), tetrakis(diethylamino) hafnium (TDEAH), tetrakis(ethylmethylamino) hafnium (TEMAH), isomers thereof, complexes thereof, abducts thereof, salts thereof, or any combination thereof.

The titanium precursor can be or include one or more of titanium cyclopentadiene compounds, one or more of titanium amino compounds, one or more of titanium alkyl compounds, one or more of titanium alkoxy compounds, substitutes thereof, complexes thereof, abducts thereof, salts thereof, or any combination thereof. Exemplary titanium precursors can be or include bis(methylcyclopentadiene) dimethyltitanium ((MeCp)₂TiMe₂), bis(methylcyclopentadiene) methylmethoxytitanium ((MeCp)₂Ti(OMe)(Me)), bis(cyclopentadiene) dimethyltitanium ((Cp)₂TiMe₂), tetra(tert-butoxy) titanium, titaniumum isopropoxide ((iPrO)₄Ti), tetrakis(dimethylamino) titanium (TDMAT), tetrakis(diethylamino) titanium (TDEAT), tetrakis(ethylmethylamino) titanium (TEMAT), isomers thereof, complexes thereof, abducts thereof, salts thereof, or any combination thereof.

In one or more examples, the first deposited layer is a chromium-containing layer which can be or include metallic chromium and the first reactant contains one or more reducing agents. In some examples, the first deposited layer is an aluminum-containing layer which can be or include metallic aluminum and the first reactant contains one or more reducing agents. In other examples, the first deposited layer is a hafnium-containing layer which can be or include metallic hafnium and the first reactant contains one or more reducing agents. Exemplary reducing agents can be or include hydrogen (H₂), ammonia, hydrazine, one or more hydrazine compounds, one or more alcohols, a cyclohexadiene, a dihydropyrazine, an aluminum containing compound, abducts thereof, salts thereof, plasma derivatives thereof, or any combination thereof.

In some examples, the first deposited layer is a chromium-containing layer which can be or include chromium oxide and the first reactant contains one or more oxidizing agents. In other examples, the first deposited layer is an aluminum-containing layer which can be or include aluminum oxide and the first reactant contains one or more oxidizing agents. In further examples, the first deposited layer is a hafnium-containing layer which can be or include hafnium oxide and the first reactant contains one or more oxidizing agents. Exemplary oxidizing agents can be or include water (e.g., steam), oxygen (O₂), atomic oxygen, ozone, nitrous oxide, one or more peroxides, one or more alcohols, plasmas thereof, or any combination thereof.

In one or more examples, the first deposited layer is a chromium-containing layer which can be or include chromium nitride and the first reactant contains one or more nitriding agents. In other examples, the first deposited layer is an aluminum-containing layer which can be or include aluminum nitride and the first reactant contains one or more nitriding agents. In some examples, the first deposited layer is a hafnium-containing layer which can be or include hafnium nitride and the first reactant contains one or more nitriding agents. Exemplary nitriding agents can be or include ammonia, atomic nitrogen, one or more hydrazines, nitric oxide, plasmas thereof, or any combination thereof.

In one or more examples, the first deposited layer is a chromium-containing layer which can be or include chromium silicide and the first reactant contains one or more silicon precursors. In some examples, the first deposited layer is an aluminum-containing layer which can be or include aluminum silicide and the first reactant contains one or more silicon precursors. In other examples, the first deposited layer is a hafnium-containing layer which can be or include hafnium silicide and the first reactant contains one or more silicon precursors. Exemplary silicon precursors can be or include silane, disilane, trisilane, tetrasilane, pentasilane, hexasilane, monochlorosilane, dichlorosilane, trichlorosilane, tetrachlorosilane, hexachlorosilane, substituted silanes, plasma derivatives thereof, or any combination thereof.

In some examples, the first deposited layer is a chromium-containing layer which can be or include chromium carbide and the first reactant contains one or more carbon precursors. In other examples, the first deposited layer is an aluminum-containing layer which can be or include aluminum carbide and the first reactant contains one or more carbon precursors. In further examples, the first deposited layer is a hafnium-containing layer which can be or include hafnium carbide and the first reactant contains one or more carbon precursors. Exemplary carbon precursors can be or include one or more alkanes, one or more alkenes, one or more alkynes, substitutes thereof, plasmas thereof, or any combination thereof.

In some embodiments, the aerospace component can be exposed to a second precursor and a second reactant to form the second deposited layer on the first deposited layer by an ALD process producing nanolaminate film. The first deposited layer and second deposited layer have different compositions from each other. In some examples, the first precursor is a different precursor than the second precursor, such as that the first precursor is a source of a first type of metal and the second precursor is a source of a second type of metal and the first and second types of metal are different.

The second precursor can be or include one or more aluminum precursors one or more hafnium precursors, one or more yttrium precursors, or any combination thereof. The second reactant can be any other reactants used as the first reactant. For example, the second reactant can be or include one or more reducing agents, one or more oxidizing agents, one or more nitriding agents, one or more silicon precursors, one or more carbon precursors, or any combination thereof, as described and discussed above. During the ALD process, each of the second precursor and the second reactant can independent include one or more carrier gases. One or more purge gases can be flowed across the aerospace component and/or throughout the processing chamber in between the exposures of the second precursor and the second reactant. In some examples, the same gas may be used as a carrier gas and a purge gas. Exemplary carrier gases and purge gases can independently be or include one or more of nitrogen (N₂), argon, helium, neon, hydrogen (H₂), or any combination thereof.

In one or more embodiments, the second deposited layer contains aluminum oxide, aluminum nitride, silicon oxide, silicon nitride, silicon carbide, yttrium oxide, yttrium nitride, yttrium silicon nitride, hafnium oxide, hafnium nitride, hafnium silicide, hafnium silicate, titanium oxide, titanium nitride, titanium silicide, titanium silicate, or any combination thereof. In one or more examples, if the first deposited layer contains aluminum oxide or aluminum nitride, then the second deposited layer does not contain aluminum oxide or aluminum nitride. Similarly, if the first deposited layer contains hafnium oxide or hafnium nitride, then the second deposited layer does not contain hafnium oxide or hafnium nitride.

Each cycle of the ALD process includes exposing the aerospace component to the second precursor, conducting a pump-purge, exposing the aerospace component to the second reactant, and conducting a pump-purge to form the second deposited layer. The order of the second precursor and the second reactant can be reversed, such that the ALD cycle includes exposing the surface of the aerospace component to the second reactant, conducting a pump-purge, exposing the aerospace component to the second precursor, and conducting a pump-purge to form the second deposited layer.

In one or more examples, during each ALD cycle, the aerospace component is exposed to the second precursor for about 0.1 seconds to about 10 seconds, the second reactant for about 0.1 seconds to about 10 seconds, and the pump-purge for about 0.5 seconds to about 30 seconds. In other examples, during each ALD cycle, the aerospace component is exposed to the second precursor for about 0.5 seconds to about 3 seconds, the second reactant for about 0.5 seconds to about 3 seconds, and the pump-purge for about 1 second to about 10 seconds.

Each ALD cycle is repeated from 2, 3, 4, 5, 6, 8, about 10, about 12, or about 15 times to about 18, about 20, about 25, about 30, about 40, about 50, about 65, about 80, about 100, about 120, about 150, about 200, about 250, about 300, about 350, about 400, about 500, about 800, about 1,000, or more times to form the second deposited layer. For example, each ALD cycle is repeated from 2 times to about 1,000 times, 2 times to about 800 times, 2 times to about 500 times, 2 times to about 300 times, 2 times to about 250 times, 2 times to about 200 times, 2 times to about 150 times, 2 times to about 120 times, 2 times to about 100 times, 2 times to about 80 times, 2 times to about 50 times, 2 times to about 30 times, 2 times to about 20 times, 2 times to about 15 times, 2 times to about 10 times, 2 times to 5 times, about 8 times to about 1,000 times, about 8 times to about 800 times, about 8 times to about 500 times, about 8 times to about 300 times, about 8 times to about 250 times, about 8 times to about 200 times, about 8 times to about 150 times, about 8 times to about 120 times, about 8 times to about 100 times, about 8 times to about 80 times, about 8 times to about 50 times, about 8 times to about 30 times, about 8 times to about 20 times, about 8 times to about 15 times, about 8 times to about 10 times, about 20 times to about 1,000 times, about 20 times to about 800 times, about 20 times to about 500 times, about 20 times to about 300 times, about 20 times to about 250 times, about 20 times to about 200 times, about 20 times to about 150 times, about 20 times to about 120 times, about 20 times to about 100 times, about 20 times to about 80 times, about 20 times to about 50 times, about 20 times to about 30 times, about 50 times to about 1,000 times, about 50 times to about 500 times, about 50 times to about 350 times, about 50 times to about 300 times, about 50 times to about 250 times, about 50 times to about 150 times, or about 50 times to about 100 times to form the second deposited layer.

The second deposited layer can have a thickness of about 0.1 nm, about 0.2 nm, about 0.3 nm, about 0.4 nm, about 0.5 nm, about 0.8 nm, about 1 nm, about 2 nm, about 3 nm, about 5 nm, about 8 nm, about 10 nm, about 12 nm, or about 15 nm to about 18 nm, about 20 nm, about 25 nm, about 30 nm, about 40 nm, about 50 nm, about 60 nm, about 80 nm, about 100 nm, about 120 nm, or about 150 nm. For example, the second deposited layer can have a thickness of about 0.1 nm to about 150 nm, about 0.2 nm to about 150 nm, about 0.2 nm to about 120 nm, about 0.2 nm to about 100 nm, about 0.2 nm to about 80 nm, about 0.2 nm to about 50 nm, about 0.2 nm to about 40 nm, about 0.2 nm to about 30 nm, about 0.2 nm to about 20 nm, about 0.2 nm to about 10 nm, about 0.2 nm to about 5 nm, about 0.2 nm to about 1 nm, about 0.2 nm to about 0.5 nm, about 0.5 nm to about 150 nm, about 0.5 nm to about 120 nm, about 0.5 nm to about 100 nm, about 0.5 nm to about 80 nm, about 0.5 nm to about 50 nm, about 0.5 nm to about 40 nm, about 0.5 nm to about 30 nm, about 0.5 nm to about 20 nm, about 0.5 nm to about 10 nm, about 0.5 nm to about 5 nm, about 0.5 nm to about 1 nm, about 2 nm to about 150 nm, about 2 nm to about 120 nm, about 2 nm to about 100 nm, about 2 nm to about 80 nm, about 2 nm to about 50 nm, about 2 nm to about 40 nm, about 2 nm to about 30 nm, about 2 nm to about 20 nm, about 2 nm to about 10 nm, about 2 nm to about 5 nm, about 2 nm to about 3 nm, about 10 nm to about 150 nm, about 10 nm to about 120 nm, about 10 nm to about 100 nm, about 10 nm to about 80 nm, about 10 nm to about 50 nm, about 10 nm to about 40 nm, about 10 nm to about 30 nm, about 10 nm to about 20 nm, or about 10 nm to about 15 nm.

In one or more examples, the first deposited layer can be or contain chromium oxide, aluminum oxide, hafnium oxide, yttrium oxide, dopants thereof, alloys thereof, or any combination thereof, and the second deposited layer can be or contain chromium oxide, aluminum oxide, hafnium oxide, yttrium oxide, dopants thereof, alloys thereof, or any combination thereof. In some examples, the first deposited layer and the second deposited layer have different compositions.

In one or more embodiments, the protective coating or the nanolaminate film stack can contain from 1, 2, 3, 4, 5, 6, 7, 8, or 9 pairs of the first and second deposited layers to about 10, about 12, about 15, about 20, about 25, about 30, about 40, about 50, about 65, about 80, about 100, about 120, about 150, about 200, about 250, about 300, about 500, about 800, or about 1,000 pairs of the first and second deposited layers. For example, the nanolaminate film stack can contain from 1 to about 1,000, 1 to about 800, 1 to about 500, 1 to about 300, 1 to about 250, 1 to about 200, 1 to about 150, 1 to about 120, 1 to about 100, 1 to about 80, 1 to about 65, 1 to about 50, 1 to about 30, 1 to about 20, 1 to about 15, 1 to about 10, 1 to about 8, 1 to about 6, 1 to 5, 1 to 4, 1 to 3, about 5 to about 150, about 5 to about 120, about 5 to about 100, about 5 to about 80, about 5 to about 65, about 5 to about 50, about 5 to about 30, about 5 to about 20, about 5 to about 15, about 5 to about 10, about 5 to about 8, about 5 to about 7, about 10 to about 150, about 10 to about 120, about 10 to about 100, about 10 to about 80, about 10 to about 65, about 10 to about 50, about 10 to about 30, about 10 to about 20, about 10 to about 15, or about 10 to about 12 pairs of the first and second deposited layers.

The protective coating or the nanolaminate film stack can have a thickness of about 1 nm, about 2 nm, about 3 nm, about 5 nm, about 8 nm, about 10 nm, about 12 nm, about 15 nm, about 20 nm, about 30 nm, about 50 nm, about 60 nm, about 80 nm, about 100 nm, or about 120 nm to about 150 nm, about 180 nm, about 200 nm, about 250 nm, about 300 nm, about 350 nm, about 400 nm, about 500 nm, about 800 nm, about 1,000 nm, about 2,000 nm, about 3,000 nm, about 4,000 nm, about 5,000 nm, about 6,000 nm, about 7,000 nm, about 8,000 nm, about 9,000 nm, about 10,000 nm, or thicker. In some examples, the protective coating or the nanolaminate film stack can have a thickness of less than 10 μm (less than 10,000 nm). For example, the protective coating or the nanolaminate film stack can have a thickness of about 1 nm to less than 10,000 nm, about 1 nm to about 8,000 nm, about 1 nm to about 6,000 nm, about 1 nm to about 5,000 nm, about 1 nm to about 3,000 nm, about 1 nm to about 2,000 nm, about 1 nm to about 1,500 nm, about 1 nm to about 1,000 nm, about 1 nm to about 500 nm, about 1 nm to about 400 nm, about 1 nm to about 300 nm, about 1 nm to about 250 nm, about 1 nm to about 200 nm, about 1 nm to about 150 nm, about 1 nm to about 100 nm, about 1 nm to about 80 nm, about 1 nm to about 50 nm, about 20 nm to about 500 nm, about 20 nm to about 400 nm, about 20 nm to about 300 nm, about 20 nm to about 250 nm, about 20 nm to about 200 nm, about 20 nm to about 150 nm, about 20 nm to about 100 nm, about 20 nm to about 80 nm, about 20 nm to about 50 nm, about 30 nm to about 400 nm, about 30 nm to about 200 nm, about 50 nm to about 500 nm, about 50 nm to about 400 nm, about 50 nm to about 300 nm, about 50 nm to about 250 nm, about 50 nm to about 200 nm, about 50 nm to about 150 nm, about 50 nm to about 100 nm, about 80 nm to about 250 nm, about 80 nm to about 200 nm, about 80 nm to about 150 nm, about 80 nm to about 100 nm, about 50 nm to about 80 nm, about 100 nm to about 500 nm, about 100 nm to about 400 nm, about 100 nm to about 300 nm, about 100 nm to about 250 nm, about 100 nm to about 200 nm, or about 100 nm to about 150 nm.

In some embodiments, the nanolaminate film stack can optionally be exposed to one or more annealing processes. In some examples, the nanolaminate film stack can be converted into the coalesced film or crystalline film during the annealing process. During the annealing process, the high temperature coalesces the layers within the nanolaminate film stack into a single structure where the new crystalline assembly enhances the integrity and protective properties of the coalesced film or crystalline film. In other examples, the nanolaminate film stack can be heated and densified during the annealing process, but still maintained as a nanolaminate film stack. The annealing process can be or include a thermal anneal (e.g., rapid thermal processing (RTP) and/or furnace annealing), a plasma anneal, a light anneal (e.g., a laser anneal, an ultraviolet anneal, an infrared anneal, or a visible light anneal), or any combination thereof.

The nanolaminate film stack and/or the protective coating disposed on the aerospace component is heated to a temperature of about 400° C., about 500° C., about 600° C., or about 700° C. to about 750° C., about 800° C., about 900° C., about 1,000° C., about 1,100° C., about 1,200° C., or greater during the annealing process. For example, the nanolaminate film stack and/or the protective coating disposed on the aerospace component is heated to a temperature of about 400° C. to about 1,200° C., about 400° C. to about 1,100° C., about 400° C. to about 1,000° C., about 400° C. to about 900° C., about 400° C. to about 800° C., about 400° C. to about 700° C., about 400° C. to about 600° C., about 400° C. to about 500° C., about 550° C. to about 1,200° C., about 550° C. to about 1,100° C., about 550° C. to about 1,000° C., about 550° C. to about 900° C., about 550° C. to about 800° C., about 550° C. to about 700° C., about 550° C. to about 600° C., about 700° C. to about 1,200° C., about 700° C. to about 1,100° C., about 700° C. to about 1,000° C., about 700° C. to about 900° C., about 700° C. to about 800° C., about 850° C. to about 1,200° C., about 850° C. to about 1,100° C., about 850° C. to about 1,000° C., or about 850° C. to about 900° C. during the annealing process.

The nanolaminate film stack and/or the protective coating can be under a vacuum at a low pressure (e.g., from about 0.1 Torr to less than 760 Torr), at ambient pressure (e.g., about 760 Torr), and/or at a high pressure (e.g., from greater than 760 Torr (1 atm) to about 3,678 Torr (about 5 atm)) during the annealing process. The nanolaminate film stack and/or the protective coating can be exposed to an atmosphere containing one or more gases during the annealing process. Exemplary gases used during the annealing process can be or include nitrogen (N₂), argon, helium, hydrogen (H₂), oxygen (O₂), or any combinations thereof. The annealing process can be performed for about 0.01 seconds to about 10 minutes. In some examples, the annealing process can be a thermal anneal and lasts for about 1 minute, about 5 minutes, about 10 minutes, or about 30 minutes to about 1 hour, about 2 hours, about 5 hours, or about 24 hours. In other examples, the annealing process can be a laser anneal or a spike anneal and lasts for about 1 millisecond, about 100 millisecond, or about 1 second to about 5 seconds, about 10 seconds, or about 15 seconds.

In some embodiments, the protective coating or the coalesced film or crystalline film can have a thickness of about 1 nm, about 2 nm, about 3 nm, about 5 nm, about 8 nm, about 10 nm, about 12 nm, about 15 nm, about 20 nm, about 30 nm, about 50 nm, about 60 nm, about 80 nm, about 100 nm, or about 120 nm to about 150 nm, about 180 nm, about 200 nm, about 250 nm, about 300 nm, about 350 nm, about 400 nm, about 500 nm, about 700 nm, about 850 nm, about 1,000 nm, about 1,200 nm, about 1,500 nm, about 2,000 nm, about 3,000 nm, about 4,000 nm, about 5,000 nm, about 6,000 nm, about 7,000 nm, about 8,000 nm, about 9,000 nm, about 10,000 nm, or thicker. In some examples, the protective coating or the coalesced film or crystalline film can have a thickness of less than 10 μm (less than 10,000 nm). For example, the protective coating or the coalesced film or crystalline film can have a thickness of about 1 nm to less than 10,000 nm, about 1 nm to about 8,000 nm, about 1 nm to about 6,000 nm, about 1 nm to about 5,000 nm, about 1 nm to about 3,000 nm, about 1 nm to about 2,000 nm, about 1 nm to about 1,500 nm, about 1 nm to about 1,000 nm, about 1 nm to about 500 nm, about 1 nm to about 400 nm, about 1 nm to about 300 nm, about 1 nm to about 250 nm, about 1 nm to about 200 nm, about 1 nm to about 150 nm, about 1 nm to about 100 nm, about 1 nm to about 80 nm, about 1 nm to about 50 nm, about 20 nm to about 500 nm, about 20 nm to about 400 nm, about 20 nm to about 300 nm, about 20 nm to about 250 nm, about 20 nm to about 200 nm, about 20 nm to about 150 nm, about 20 nm to about 100 nm, about 20 nm to about 80 nm, about 20 nm to about 50 nm, about 30 nm to about 400 nm, about 30 nm to about 200 nm, about 50 nm to about 500 nm, about 50 nm to about 400 nm, about 50 nm to about 300 nm, about 50 nm to about 250 nm, about 50 nm to about 200 nm, about 50 nm to about 150 nm, about 50 nm to about 100 nm, about 80 nm to about 250 nm, about 80 nm to about 200 nm, about 80 nm to about 150 nm, about 80 nm to about 100 nm, about 50 nm to about 80 nm, about 100 nm to about 500 nm, about 100 nm to about 400 nm, about 100 nm to about 300 nm, about 100 nm to about 250 nm, about 100 nm to about 200 nm, or about 100 nm to about 150 nm.

In one or more embodiments, the protective coating can have a relatively high degree of uniformity. The protective coating can have a uniformity of less than 50%, less than 40%, or less than 30% of the thickness of the respective protective coating. The protective coating can have a uniformity from about 0%, about 0.5%, about 1%, about 2%, about 3%, about 5%, about 8%, or about 10% to about 12%, about 15%, about 18%, about 20%, about 22%, about 25%, about 28%, about 30%, about 35%, about 40%, about 45%, or less than 50% of the thickness. For example, the protective coating can have a uniformity from about 0% to about 50%, about 0% to about 40%, about 0% to about 30%, about 0% to less than 30%, about 0% to about 28%, about 0% to about 25%, about 0% to about 20%, about 0% to about 15%, about 0% to about 10%, about 0% to about 8%, about 0% to about 5%, about 0% to about 3%, about 0% to about 2%, about 0% to about 1%, about 1% to about 50%, about 1% to about 40%, about 1% to about 30%, about 1% to less than 30%, about 1% to about 28%, about 1% to about 25%, about 1% to about 20%, about 1% to about 15%, about 1% to about 10%, about 1% to about 8%, about 1% to about 5%, about 1% to about 3%, about 1% to about 2%, about 5% to about 50%, about 5% to about 40%, about 5% to about 30%, about 5% to less than 30%, about 5% to about 28%, about 5% to about 25%, about 5% to about 20%, about 5% to about 15%, about 5% to about 10%, about 5% to about 8%, about 10% to about 50%, about 10% to about 40%, about 10% to about 30%, about 10% to less than 30%, about 10% to about 28%, about 10% to about 25%, about 10% to about 20%, about 10% to about 15%, or about 10% to about 12% of the thickness.

In some embodiments, the protective coating can contain, be formed with, or otherwise produced with different ratios of metals throughout the material, such as one or more doping metals and/or one or more grading metals contained within a base metal, where any of the metals can be in any chemically oxidized form or state (e.g., oxide, nitride, silicide, carbide, or combinations thereof). In one or more examples, the first deposited layer is deposited to first thickness and the second deposited layer is deposited to a second thickness. The first thickness can be the same as the second thickness or the first thickness can be different than (less than or greater than) the second thickness. For example, the first deposited layer can be deposited by two or more (3, 4, 5, 6, 7, 8, 9, 10, or more) ALD cycles to produce the respectively same amount of sub-layers (e.g., one sub-layer for each ALD cycle), and then the second deposited layer can be deposited by one ALD cycle or a number of ALD cycles that is less than or greater than the number of ALD cycles used to deposit the first deposited layer. In other examples, the first deposited layer can be deposited by CVD to a first thickness and the second deposited layer is deposited by ALD to a second thickness which is less than the first thickness.

In other embodiments, an ALD process can be used to deposit the first deposited layer and/or the second deposited layer where the deposited material is doped by including a dopant precursor during the ALD process. In some examples, the dopant precursor can be included a separate ALD cycle relative to the ALD cycles used to deposit the base material. In other examples, the dopant precursor can be co-injected with any of the chemical precursors used during the ALD cycle. In further examples, the dopant precursor can be injected separate from the chemical precursors during the ALD cycle. For example, one ALD cycle can include exposing the aerospace component to: the first precursor, a pump-purge, the dopant precursor, a pump-purge, the first reactant, and a pump-purge to form the deposited layer. In some examples, one ALD cycle can include exposing the aerospace component to: the dopant precursor, a pump-purge, the first precursor, a pump-purge, the first reactant, and a pump-purge to form the deposited layer. In other examples, one ALD cycle can include exposing the aerospace component to: the first precursor, the dopant precursor, a pump-purge, the first reactant, and a pump-purge to form the deposited layer.

In one or more embodiments, the first deposited layer and/or the second deposited layer contains one or more base materials and one or more doping materials. The base material is or contains aluminum oxide, chromium oxide, or a combination of aluminum oxide and chromium oxide. The doping material is or contains hafnium, hafnium oxide, yttrium, yttrium oxide, cerium, cerium oxide, silicon, silicon oxide, nitrides thereof, or any combination thereof. Any of the precursors or reagents described herein can be used as a doping precursor or a dopant. Exemplary cerium precursor can be or include one or more cerium(IV) tetra(2,2,6,6-tetramethyl-3,5-heptanedionate) (Ce(TMHD)₄), tris(cyclopentadiene) cerium ((C₅H₅)₃Ce), tris(propylcyclopentadiene) cerium ([(C₃H₇)C₅H₄]₃Ce), tris(tetramethylcyclopentadiene) cerium ([(CH₃)₄C₅H]₃Ce), or any combination thereof.

The doping material can have a concentration of about 0.01 atomic percent (at %), about 0.05 at %, about 0.08 at %, about 0.1 at %, about 0.5 at %, about 0.8 at %, about 1 at %, about 1.2 at %, about 1.5 at %, about 1.8 at %, or about 2 at % to about 2.5 at %, about 3 at %, about 3.5 at %, about 4 at %, about 5 at %, about 8 at %, about 10 at %, about 15 at %, about 20 at %, about 25 at %, or about 30 at % within the first deposited layer, the second deposited layer, the nanolaminate film stack, and/or the coalesced film or crystalline film. For example, the doping material can have a concentration of about 0.01 at % to about 30 at %, about 0.01 at % to about 25 at %, about 0.01 at % to about 20 at %, about 0.01 at % to about 15 at %, about 0.01 at % to about 12 at %, about 0.01 at % to about 10 at %, about 0.01 at % to about 8 at %, about 0.01 at % to about 5 at %, about 0.01 at % to about 4 at %, about 0.01 at % to about 3 at %, about 0.01 at % to about 2.5 at %, about 0.01 at % to about 2 at %, about 0.01 at % to about 1.5 at %, about 0.01 at % to about 1 at %, about 0.01 at % to about 0.5 at %, about 0.01 at % to about 0.1 at %, about 0.1 at % to about 30 at %, about 0.1 at % to about 25 at %, about 0.1 at % to about 20 at %, about 0.1 at % to about 15 at %, about 0.1 at % to about 12 at %, about 0.1 at % to about 10 at %, about 0.1 at % to about 8 at %, about 0.1 at % to about 5 at %, about 0.1 at % to about 4 at %, about 0.1 at % to about 3 at %, about 0.1 at % to about 2.5 at %, about 0.1 at % to about 2 at %, about 0.1 at % to about 1.5 at %, about 0.1 at % to about 1 at %, about 0.1 at % to about 0.5 at %, about 1 at % to about 30 at %, about 1 at % to about 25 at %, about 1 at % to about 20 at %, about 1 at % to about 15 at %, about 1 at % to about 12 at %, about 1 at % to about 10 at %, about 1 at % to about 8 at %, about 1 at % to about 5 at %, about 1 at % to about 4 at %, about 1 at % to about 3 at %, about 1 at % to about 2.5 at %, about 1 at % to about 2 at %, or about 1 at % to about 1.5 at % within the first deposited layer, the second deposited layer, the nanolaminate film stack, and/or the coalesced film or crystalline film.

In one or more embodiments, the protective coating includes the nanolaminate film stack having the first deposited layer containing aluminum oxide (or other base material) and the second deposited layer containing hafnium oxide (or other doping material), or having the first deposited layer containing hafnium oxide (or other doping material) and the second deposited layer containing aluminum oxide (or other base material). In one or more examples, the protective coating contains a combination of aluminum oxide and hafnium oxide, a hafnium-doped aluminum oxide, hafnium aluminate, or any combination thereof. For example, the protective coating includes the nanolaminate film stack having the first deposited layer contains aluminum oxide and the second deposited layer contains hafnium oxide, or having the first deposited layer contains hafnium oxide and the second deposited layer contains aluminum oxide. In other examples, the protective coating includes the coalesced film or crystalline film formed from layers of aluminum oxide and hafnium oxide. In one or more embodiments, the protective coating has a concentration of hafnium (or other doping material) of about 0.01 at %, about 0.05 at %, about 0.08 at %, about 0.1 at %, about 0.5 at %, about 0.8 at %, or about 1 at % to about 1.2 at %, about 1.5 at %, about 1.8 at %, about 2 at %, about 2.5 at %, about 3 at %, about 3.5 at %, about 4 at %, about 4.5 at %, or about 5 at % within the nanolaminate film stack or the coalesced film or crystalline film containing aluminum oxide (or other base material). For example, the protective coating has a concentration of hafnium (or other doping material) of about 0.01 at % to about 10 at %, about 0.01 at % to about 8 at %, about 0.01 at % to about 5 at %, about 0.01 at % to about 4 at %, about 0.01 at % to about 3 at %, about 0.01 at % to about 2.5 at %, about 0.01 at % to about 2 at %, about 0.01 at % to about 1.5 at %, about 0.01 at % to about 1 at %, about 0.01 at % to about 0.5 at %, about 0.01 at % to about 0.1 at %, about 0.01 at % to about 0.05 at %, about 0.1 at % to about 5 at %, about 0.1 at % to about 4 at %, about 0.1 at % to about 3 at %, about 0.1 at % to about 2.5 at %, about 0.1 at % to about 2 at %, about 0.1 at % to about 1.5 at %, about 0.1 at % to about 1 at %, about 0.1 at % to about 0.5 at %, about 0.5 at % to about 5 at %, about 0.5 at % to about 4 at %, about 0.5 at % to about 3 at %, about 0.5 at % to about 2.5 at %, about 0.5 at % to about 2 at %, about 0.5 at % to about 1.5 at %, about 0.5 at % to about 1 at %, about 1 at % to about 5 at %, about 1 at % to about 4 at %, about 1 at % to about 3 at %, about 1 at % to about 2.5 at %, about 1 at % to about 2 at %, or about 1 at % to about 1.5 at % within the nanolaminate film stack or the coalesced film or crystalline film containing aluminum oxide (or other base material).

Aerospace components as described and discussed herein, including aerospace component, can be or include one or more components or portions thereof of a fuel system, a turbine, an aircraft, a spacecraft, or other devices that can include one or more turbines (e.g., compressors, pumps, turbo fans, super chargers, and the like). Exemplary aerospace components can be or include one or more turbine blades, turbine blade roots (e.g., fir tree or dovetail), turbine disks, or any combination thereof. In other embodiments, the aerospace components as described and discussed herein can be or include any other aerospace component or part that can benefit from having protective coating deposited thereon.

The aerospace component has one or more outer or exterior surfaces and one or more inner or interior surfaces. The protective coating can be deposited or otherwise formed on interior surfaces and/or exterior surfaces of the aerospace components. The interior surfaces can define one or more cavities extending or contained within the aerospace component. The cavities can be channels, passages, spaces, or the like disposed between the interior surfaces. The cavity can have one or more openings. Each of the cavities within the aerospace component typically have aspect ratios (e.g., length divided by width) of greater than 1. The methods described and discussed herein provide depositing and/or otherwise forming the protective coating on the interior surfaces with high aspect ratios (greater than 1) and/or within the cavities.

The aspect ratio of the cavity can be from about 2, about 3, about 5, about 8, about 10, or about 12 to about 15, about 20, about 25, about 30, about 40, about 50, about 65, about 80, about 100, about 120, about 150, about 200, about 250, about 300, about 500, about 800, about 1,000, or greater. For example, the aspect ratio of the cavity can be from about 2 to about 1,000, about 2 to about 500, about 2 to about 200, about 2 to about 150, about 2 to about 120, about 2 to about 100, about 2 to about 80, about 2 to about 50, about 2 to about 40, about 2 to about 30, about 2 to about 20, about 2 to about 10, about 2 to about 8, about 5 to about 1,000, about 5 to about 500, about 5 to about 200, about 5 to about 150, about 5 to about 120, about 5 to about 100, about 5 to about 80, about 5 to about 50, about 5 to about 40, about 5 to about 30, about 5 to about 20, about 5 to about 10, about 5 to about 8, about 10 to about 1,000, about 10 to about 500, about 10 to about 200, about 10 to about 150, about 10 to about 120, about 10 to about 100, about 10 to about 80, about 10 to about 50, about 10 to about 40, about 10 to about 30, about 10 to about 20, about 20 to about 1,000, about 20 to about 500, about 20 to about 200, about 20 to about 150, about 20 to about 120, about 20 to about 100, about 20 to about 80, about 20 to about 50, about 20 to about 40, or about 20 to about 30.

The aerospace component (e.g., turbine blade, root, or turbine disk) and any surface thereof including one or more outer or exterior surfaces and/or one or more inner or interior surfaces can be made of, contain, or otherwise include one or more metals, such as nickel, chromium, cobalt, chromium-cobalt alloys, molybdenum, iron, titanium, one or more nickel superalloys, one or more Cannon-Muskegon alloys, one or more PWA alloys, Rene alloys, one or more Inconel alloys, one or more Hastelloy alloys, one or more Invar alloys, one or more Inovoco alloys, alloys thereof, or any combination thereof. The protective coating can be deposited, formed, or otherwise produced on any surface of the aerospace component including one or more outer or exterior surfaces and/or one or more inner or interior surfaces.

The protective coating, as described and discussed herein, can be or include one or more of laminate film stacks, coalesced films, crystalline film, graded compositions, and/or monolithic films which are deposited or otherwise formed on any surface of an aerospace component. In some examples, the protective coating contains from about 1% to about 100% chromium oxide. The protective coating is conformal and substantially coat rough surface features following surface topology, including in open pores, blind holes, and non-line-of sight regions of a surface. The protective coating does not substantially increase surface roughness, and in some embodiments, the protective coating may reduce surface roughness by conformally coating roughness until it coalesces. The protective coating may contain particles from the deposition that are substantially larger than the roughness of the aerospace component, but are considered separate from the monolithic film. The protective coating is substantially well adhered and pinhole free. The thicknesses of the protective coating can vary within 1-sigma of 40%. In one or more embodiments, the thickness varies less than 1-sigma of 20%, 10%, 5%, 1%, or 0.1%.

The protective coating provides corrosion and oxidation protection when the aerospace components are exposed to air, oxygen, sulfur and/or sulfur compounds, acids, bases, salts (e.g., Na, K, Mg, Li, or Ca salts), or any combination thereof. The aerospace component may be exposed to these conditions during normal operation or during a cleaning process to remove any carbon buildup.

One or more embodiments described herein include methods for the preservation of an underneath chromium-containing alloy using the methods producing an alternating nanolaminate of first material (e.g., chromium oxide, aluminum oxide, and/or aluminum nitride) and another secondary material. The secondary material can be or include one or more of aluminum oxide, aluminum nitride, aluminum oxynitride, silicon oxide, silicon nitride, silicon carbide, yttrium oxide, yttrium nitride, yttrium silicon nitride, hafnium oxide, hafnium silicate, hafnium silicide, hafnium nitride, titanium oxide, titanium nitride, titanium silicide, titanium silicate, dopants thereof, alloys thereof, or any combination thereof. The resultant film can be used as a nanolaminate film stack or the film can be subjected to annealing where the high temperature coalesces the films into a single structure where the new crystalline assembly enhances the integrity and protective properties of this overlying film.

In a particular embodiment, the chromium precursor (at a temperature of about 0° C. to about 250° C.) is delivered to the aerospace component via vapor phase delivery for at pre-determined pulse length of about 5 seconds. During this process, the deposition reactor is operated under a flow of nitrogen carrier gas (about 1,000 sccm total) with the chamber held at a pre-determined temperature of about 350° C. and pressure of about 3.5 Torr. After the pulse of the chromium precursor, the chamber is then subsequently pumped and purged of all requisite gases and byproducts for a determined amount of time. Subsequently, water (or another oxidizing agent) is pulsed into the chamber for about 0.1 seconds at chamber pressure of about 3.5 Torr. An additional chamber purge (or pump/purge) is then performed to rid the reactor of any excess reactants and reaction byproducts. This process is repeated as many times as necessary to get the target chromium oxide film to the desired film thickness.

In one or more examples, the secondary film (e.g., containing aluminum oxide) can be produced by delivering the precursor (e.g., trimethylaluminum at a temperature of about 0° C. to about 30° C.) to the aerospace component via vapor phase delivery for at pre-determined pulse length of about 0.1 seconds. During this process, the deposition reactor is operated under a flow of nitrogen carrier gas (about 100 sccm total) with the chamber held at a pre-determined temperature of about 150° C. to about 350° C. and pressure about 1 Torr to about 5 Torr. After the pulse of trimethylaluminum, the chamber is then subsequently pumped and purged of all requisite gases and byproducts for a determined amount of time. Subsequently, water vapor is pulsed into the chamber for about 0.1 seconds at chamber pressure of about 3.5 Torr. An additional chamber purge is then performed to rid the reactor of any excess reactants and reaction byproducts. This process is repeated as many times as necessary to get the target aluminum oxide film to the desired film thickness. The aerospace component is then subjected to an annealing furnace at a temperature of about 500° C. under inert nitrogen flow of about 500 sccm for about one hour.

Embodiments of the present disclosure further relate to any one or more of the following paragraphs 1-29:

1. A turbine blade, comprising: a blade portion; and a root coupled to the blade portion and comprising a protective coating disposed on the root, wherein the protective coating comprises: a deposited crystalline film comprising at least one of a metal oxide, a metal nitride, or a metal oxynitride (e.g., a deposited crystalline metal oxide film) and having a thickness of about 100 nm to about 10 μm.

2. A turbine blade assembly, comprising: a disk; and a plurality of the turbine blades of paragraph 1, wherein each of the turbine blades is coupled to the disk.

3. The turbine blade assembly of paragraph 2, wherein the disk comprises a plurality of receiving surfaces, and wherein each of the turbine blades is coupled to a respective receiving surface of the plurality of receiving surfaces.

4. The turbine blade assembly of paragraph 3, wherein each of the receiving surfaces comprises a disk protective coating disposed thereon.

5. The turbine blade assembly of paragraph 4, wherein the disk protective coating comprises: a second deposited crystalline film comprising at least one of a metal oxide, a metal nitride, or a metal oxynitride (e.g., a second deposited crystalline metal oxide film) and having a thickness of about 100 nm to about 10 μm.

6. The turbine blade assembly according to any one of paragraphs 2-5, wherein the plurality of the turbine blades comprises about 50 blades to about 200 blades.

7. The turbine blade and/or the turbine blade assembly according to any one of paragraphs 1-6, wherein each of the protective coating and the disk protective coating independently has a thickness of about 200 nm to about 5 μm.

8. The turbine blade and/or the turbine blade assembly according to any one of paragraphs 1-7, wherein each of the protective coating and the disk protective coating independently has a thickness of about 500 nm to about 2 μm.

9. The turbine blade and/or the turbine blade assembly according to any one of paragraphs 1-8, wherein each of the protective coating and the disk protective coating independently comprises one or more crystalline materials selected from aluminum oxide, aluminum silicate, aluminum nitride, aluminum oxynitride, chromium oxide, chromium silicate, silicon oxide, silicon nitride, silicon carbide, yttrium oxide, yttrium silicate, yttrium nitride, yttrium silicon nitride, hafnium oxide, hafnium nitride, hafnium silicide, hafnium silicate, titanium oxide, titanium nitride, titanium silicide, titanium silicate, dopants thereof, alloys thereof, or any combination thereof.

10. The turbine blade and/or the turbine blade assembly according to any one of paragraphs 1-9, wherein each of the protective coating and the disk protective coating independently comprises one or more crystalline materials selected from aluminum oxide, chromium oxide, hafnium oxide, yttrium oxide, dopants thereof, alloys thereof, or any combination thereof.

11. The turbine blade and/or the turbine blade assembly according to any one of paragraphs 1-10, wherein each of the protective coating, the deposited crystalline film, the deposited crystalline metal oxide film, the disk protective coating, the second deposited crystalline film, and/or the second deposited crystalline metal oxide film is independently deposited by an atomic layer deposition (ALD) process, a plasma-enhanced ALD (PE-ALD) process, a thermal chemical vapor deposition (CVD) process, a plasma-enhanced CVD (PE-CVD) process, a pulsed-CVD process, a physical vapor deposition (PVD) process, or any combination thereof.

12. The turbine blade and/or the turbine blade assembly according to any one of paragraphs 1-11, wherein each of the protective coating, the deposited crystalline film, the deposited crystalline metal oxide film, the disk protective coating, the second deposited crystalline film, and/or the second deposited crystalline metal oxide film is independently annealed by a thermal anneal, a plasma anneal, a light anneal, or any combination thereof.

13. The turbine blade and/or the turbine blade assembly according to paragraph 12, wherein each of the protective coating, the deposited crystalline film, the deposited crystalline metal oxide film, the disk protective coating, the second deposited crystalline film, and/or the second deposited crystalline metal oxide film is independently annealed by rapid thermal processing (RTP), a laser anneal, an ultraviolet anneal, an infrared anneal, a visible light anneal, or any combination thereof.

14. The turbine blade and/or the turbine blade assembly according to any one of paragraphs 1-13, wherein each of the protective coating, the deposited crystalline film, the deposited crystalline metal oxide film, the disk protective coating, the second deposited crystalline film, and/or the second deposited crystalline metal oxide film independently has a thickness variation of less than 20%.

15. The turbine blade and/or the turbine blade assembly according to any one of paragraphs 1-14, wherein each of the protective coating, the deposited crystalline film, the deposited crystalline metal oxide film, the disk protective coating, the second deposited crystalline film, and/or the second deposited crystalline metal oxide film independently has a thickness variation of less than 10%.

16. The turbine blade and/or the turbine blade assembly according to any one of paragraphs 1-15, wherein each of the protective coating, the deposited crystalline film, the deposited crystalline metal oxide film, the disk protective coating, the second deposited crystalline film, and/or the second deposited crystalline metal oxide film independently has a thickness variation of less than 5%.

17. A method for depositing a protective coating on a turbine blade, comprising: depositing the protective coating on the turbine blade during a vapor deposition process, wherein: the turbine blade comprises a root coupled to a blade portion, the protective coating is deposited on the root of the turbine blade, the protective coating comprises a deposited crystalline film comprising at least one of a metal oxide, a metal nitride, or a metal oxynitride (e.g., deposited crystalline metal oxide film), and the protective coating has a thickness of about 100 nm to about 10 μm.

18. A method for depositing a protective coating on a turbine disk, comprising: depositing a disk protective coating on the turbine disk during a vapor deposition process, wherein: the turbine disk comprises a plurality of receiving surfaces configured to couple to a plurality of turbine blades, the disk protective coating is deposited on at least each of the receiving surfaces, the disk protective coating comprises a deposited crystalline film comprising at least one of a metal oxide, a metal nitride, or a metal oxynitride (e.g., deposited crystalline metal oxide film), and the disk protective coating has a thickness of about 100 nm to about 10 μm

19. The method according to paragraph 17 or 18, wherein each of the protective coating and the disk protective coating independently has a thickness of about 200 nm to about 5 μm.

20. The method according to any one of paragraphs 17-19, wherein each of the protective coating and the disk protective coating independently has a thickness of about 500 nm to about 2 μm.

21. The method according to any one of paragraphs 17-20, wherein each of the protective coating and the disk protective coating independently comprises one or more crystalline materials selected from aluminum oxide, aluminum silicate, aluminum nitride, aluminum oxynitride, chromium oxide, chromium silicate, silicon oxide, silicon nitride, silicon carbide, yttrium oxide, yttrium silicate, yttrium nitride, yttrium silicon nitride, hafnium oxide, hafnium nitride, hafnium silicide, hafnium silicate, titanium oxide, titanium nitride, titanium silicide, titanium silicate, dopants thereof, alloys thereof, or any combination thereof.

22. The method according to any one of paragraphs 17-21, wherein each of the protective coating and the disk protective coating independently comprises one or more crystalline materials selected from aluminum oxide, chromium oxide, hafnium oxide, yttrium oxide, dopants thereof, alloys thereof, or any combination thereof.

23. The method according to any one of paragraphs 17-22, wherein each of the protective coating, the deposited crystalline film, the deposited crystalline metal oxide film, the disk protective coating, the second deposited crystalline film, and/or the second deposited crystalline metal oxide film is independently deposited by an atomic layer deposition (ALD) process, a plasma-enhanced ALD (PE-ALD) process, a thermal chemical vapor deposition (CVD) process, a plasma-enhanced CVD (PE-CVD) process, a pulsed-CVD process, a physical vapor deposition (PVD) process, or any combination thereof.

24. The method according to any one of paragraphs 17-23, wherein each of the protective coating, the deposited crystalline film, the deposited crystalline metal oxide film, the disk protective coating, the second deposited crystalline film, and/or the second deposited crystalline metal oxide film is independently annealed by a thermal anneal, a plasma anneal, a light anneal, or any combination thereof.

25. The method according to any one of paragraphs 17-24, wherein each of the protective coating, the deposited crystalline film, the deposited crystalline metal oxide film, the disk protective coating, the second deposited crystalline film, and/or the second deposited crystalline metal oxide film is independently annealed by rapid thermal processing (RTP), a laser anneal, an ultraviolet anneal, an infrared anneal, a visible light anneal, or any combination thereof.

26. The method according to any one of paragraphs 17-25, wherein each of the protective coating, the deposited crystalline film, the deposited crystalline metal oxide film, the disk protective coating, the second deposited crystalline film, and/or the second deposited crystalline metal oxide film independently has a thickness variation of less than 20%.

27. The method according to any one of paragraphs 17-26, wherein each of the protective coating, the deposited crystalline film, the deposited crystalline metal oxide film, the disk protective coating, the second deposited crystalline film, and/or the second deposited crystalline metal oxide film independently has a thickness variation of less than 10%.

28. The method according to any one of paragraphs 17-27, wherein each of the protective coating, the deposited crystalline film, the deposited crystalline metal oxide film, the disk protective coating, the second deposited crystalline film, and/or the second deposited crystalline metal oxide film independently has a thickness variation of less than 5%.

29. A turbine blade, a turbine blade assembly, an aerospace component or part, and/or any other components or parts prepared by the method according to any one of paragraphs 17-28.

While the foregoing is directed to embodiments of the disclosure, other and further embodiments may be devised without departing from the basic scope thereof, and the scope thereof is determined by the claims that follow. All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below.

What is claimed is:

1. A turbine blade assembly, comprising:
a disk; and
a plurality of turbine blades coupled to the disk,
wherein each of the turbine blades comprises:
a blade portion; and
a root coupled to the blade portion and comprising a protective coating disposed on the root, wherein the protective coating comprises:
a deposited crystalline film comprising at least one of a metal oxide, a metal nitride, or a metal oxynitride, and
a thickness of about 100 nm to about 10 μm.

2. The turbine blade assembly of claim 1, wherein the disk comprises a plurality of receiving surfaces, and wherein each of the turbine blades is coupled to a respective receiving surface of the plurality of receiving surfaces.

3. The turbine blade assembly of claim 2, wherein each of the receiving surfaces comprises a disk protective coating disposed thereon.

4. The turbine blade assembly of claim 3, wherein the disk protective coating comprises:
a second deposited crystalline comprising at least one of a metal oxide, a metal nitride, or a metal oxynitride, and
a thickness of about 100 nm to about 10 μm.

5. The turbine blade assembly of claim 4, wherein the plurality of the turbine blades comprises about 50 blades to about 200 blades.

6. The turbine blade assembly of claim 3, wherein each of the protective coating and the disk protective coating independently has a thickness of about 200 nm to about 5 μm.

7. The turbine blade assembly of claim 1, wherein the protective coating has a thickness of about 500 nm to about 2 μm.

8. The turbine blade assembly of claim 1, wherein the protective coating comprises one or more crystalline materials selected from aluminum oxide, aluminum silicate, aluminum nitride, aluminum oxynitride, chromium oxide, chromium silicate, silicon oxide, silicon nitride, silicon carbide, yttrium oxide, yttrium silicate, yttrium nitride, yttrium silicon nitride, hafnium oxide, hafnium nitride, hafnium silicide, hafnium silicate, titanium oxide, titanium nitride, titanium silicide, titanium silicate, dopants thereof, alloys thereof, or any combination thereof.

9. The turbine blade assembly of claim 1, wherein the protective coating comprises one or more crystalline materials selected from aluminum oxide, chromium oxide, hafnium oxide, yttrium oxide, dopants thereof, alloys thereof, or any combination thereof.

10. The turbine blade assembly of claim 1, wherein each of the protective coating and the deposited crystalline film is independently deposited by an atomic layer deposition (ALD) process, a plasma-enhanced ALD (PE-ALD) process, a thermal chemical vapor deposition (CVD) process, a plasma-enhanced CVD (PE-CVD) process, a pulsed-CVD process, a physical vapor deposition (PVD) process, or any combination thereof.

11. The turbine blade assembly of claim 1, wherein each of the protective coating and the deposited crystalline film is independently annealed by a thermal anneal, a plasma anneal, a light anneal, or any combination thereof.

12. The turbine blade assembly of claim 11, wherein each of the protective coating and the deposited crystalline film is independently annealed by rapid thermal processing (RTP), a laser anneal, an ultraviolet anneal, an infrared anneal, a visible light anneal, or any combination thereof.

13. The turbine blade assembly of claim 1, wherein each of the protective coating and the deposited crystalline film independently has a thickness variation of less than 20%.

14. The turbine blade assembly of claim 1, wherein each of the protective coating and the deposited crystalline film independently has a thickness variation of less than 10%.

15. The turbine blade assembly of claim 1, wherein each of the protective coating and the deposited crystalline film independently has a thickness variation of less than 5%.

16. A turbine blade assembly, comprising:
a disk; and
a plurality of turbine blades coupled to the disk,
wherein each of the turbine blades comprises:
a blade portion; and
a root coupled to the blade portion and comprising a protective coating disposed on the root, wherein the protective coating comprises:
a deposited crystalline film comprising at least one of a metal oxide, a metal nitride, or a metal oxynitride, and
a thickness of about 100 nm to about 10 μm,
wherein the disk comprises a plurality of receiving surfaces,
wherein each of the turbine blades is coupled to a respective receiving surface of the plurality of receiving surfaces,
wherein each of the receiving surfaces comprises a disk protective coating disposed thereon, and
wherein each of the protective coating and the disk protective coating independently has a thickness of about 200 nm to about 5 μm.

17. The turbine blade assembly of claim 16, wherein the disk protective coating comprises:
a second deposited crystalline film comprising at least one of a metal oxide, a metal nitride, or a metal oxynitride, and
a thickness of about 100 nm to about 10 μm.

18. The turbine blade assembly of claim 16, wherein each of the protective coating and the disk protective coating independently has a thickness of about 500 nm to about 2 μm.

19. The turbine blade assembly of claim 16, wherein each of the protective coating and the disk protective coating independently comprises one or more crystalline materials selected from aluminum oxide, chromium oxide, hafnium oxide, yttrium oxide, dopants thereof, alloys thereof, or any combination thereof.

20. A turbine blade, comprising:
a blade portion; and
a root coupled to the blade portion and comprising a protective coating disposed on the root, wherein the protective coating comprises:
a deposited crystalline film comprising at least one of a metal oxide, a metal nitride, or a metal oxynitride, and
a thickness of about 100 nm to about 10 μm.
